(19) United States
(12) Patent Application Publication
(10) Pub. No.: US 2009/0234515 A1
(43) Pub. Date: Sep. 17, 2009

(54) Organization system for influencing a system

(76) Inventors: Rudolf Messerschmidt, Sibbesse (DE); Rodolfo Mann Pelz, Hannover (DE); Ralf Flemme, Hannover (DE)

Correspondence Address: KENYON & KENYON LLP, ONE BROADWAY, NEW YORK, NY, 10004, US

(21) Appl. No.: 11/991,323

(22) PCT Filed: Aug. 29, 2006
(86) PCT No.: PCT/EP2006/065764

§ 371 Date: Feb. 12, 2009

(30) Foreign Application Priority Data
Sep. 2, 2005 (DE) 10 2005 041 657.8

(51) Int. Cl. G06F 19/00

(52) U.S. Cl. 701/1

(57) ABSTRACT

The organization system is designed for influencing a system, in particular a vehicle system, during ongoing operation of the system. The organization system has an adaptation manager and adaptive software components, each having an interface. The adaptation manager sets, adapts and/or controls the adaptive software components through the interfaces. The adaptation manager may have a system interface through which presettings of the systems are modifiable.

### FIELD OF THE INVENTION

The present invention relates to an organization system for influencing a system, in particular a vehicle system, a method for influencing such a system, and a corresponding computer program and computer program product.

### BACKGROUND INFORMATION

Software systems are becoming increasingly complex, with very many different software modules or applications being used simultaneously on such software systems. The “Open Services Gateway initiative” (OSGi) standard defines a component-based, service-oriented application framework which is utilized in particular for expandable complex software systems. A configuration management system is standardized for software components under OSGi. However, standardized settings and controlling options for adaptive software components are lacking.

In the network field (Internet/Intranet), the principle of “quality of service” is known. When streaming audio and video data, for example, various transmission qualities are defined here which are dependent on limiting conditions such as available bandwidth and billable costs. On a local computer or driver information system, the previous related art includes dynamic adaptivity only within the framework of operating systems on the thread and process level (scheduling and priority management).

Publication DE 100 44 319 A1 shows an electronic system for a vehicle that includes first components for performing control tasks during operational sequences of the vehicle, and second components that coordinate interaction of the first components to perform the control tasks. The first components carry out the control tasks through use of operational functions and basic functions.

### SUMMARY OF THE INVENTION

Starting from this basis, an organization system is presented having the features described herein, a method having the features described herein, a computer program having the features described herein, and a computer program product having the features described herein.

The organization system according to the present invention is designed for influencing a system, in particular a vehicle system, during ongoing operation of the system. The organization system has an adaptation manager and adaptive software components, each having an interface. It is intended that the adaptation manager set, adapt and/or control the adaptive software components through the interfaces.

The organization system may be integrated into the system to be influenced, and thus may also influence itself when influencing the system. Alternatively, the organization system may influence the system from outside.

The method according to the present invention for influencing a system, in particular a vehicle system, during ongoing operation of the system is carried out by an adaptation manager and adaptive software components, each of these adaptive software components having an interface. The adaptive software components are set, adapted and/or controlled here by the adaptation manager through the interfaces.

The computer program according to the present invention having a program code arrangement to carry out all of the steps of the method according to the present invention when this computer program is executed on a computer or a corresponding arithmetic-logic unit, in particular in a system having the organization system according to the present invention.

The computer program product according to the present invention having a program code arrangement that is stored on a computer-readable data medium is designed to carry out all of the steps of the method according to the present invention when the computer program is executed on a computer or a corresponding arithmetic-logic unit, in particular in a system having the organization system according to the present invention.

The adaptive software components of the organization system make it possible, when carrying out the method, to quickly change the resource needs and range of features during ongoing operation of the system, depending on the system status. This is particularly practical at the application level. All adaptive software components contain a uniform or identically designed interface (“adaptation interface”) via which the adaptation manager may influence and/or manage the software components and thus sets, controls and/or adapts them.

The adaptivity is particularly advantageous in the case of open software platforms having hardware linking, in which additional, possibly adaptive software components may be subsequently installed and/or exchanged through software updates and/or software upgrades.

The range of features and the resource needs of software components may be reduced without restarting the system in order to make room for newly loaded software modules and/or components. As a result of the well- and uniformly defined adaptation interface, software systems are thus clearly designed and simple to maintain.

The adaptivity principle is a particularly appealing choice for complex embedded systems, for example multimedia systems in vehicles or motor vehicles, where an end user does not wish to or should not be constantly intervening in the system or starting new programs manually, and where system resources, in particular memory space, are relatively limited. Here the organization system is able to act relatively autonomously and ensure that all of the important functionalities are available without constraint.

In addition, simplified scaling of an entire application platform of the system becomes possible, i.e., software of a certain size, for example, may be transferred more easily to a hardware platform of the system having less memory (space), since a range of features or resource needs may be adapted easily by the adaptation manager and its presettings.

In the case of a necessary load reduction, due to an effect of the adaptive software components and of the adaptation manager, the applications of the system may be adapted or adjusted so that the outwardly visible change is minimal.

The adaptation manager as a software module controls the adaptive software components of the system through the uniform interface (“adaptation interface”). The range of adaptive functions and the resource needs of the adaptive software components and/or of the system are characterized by a plurality of adaptation levels per adaptive software component, for example for a full or medium range of functions as well as a standby mode. There is provision for the adaptive software components to implement and offer operating modes corresponding to these. The adaptation manager and the individual adaptive software components all communicate via the interfaces. The adaptation manager is able to ascertain the current adaptation level of the adaptive software components via this interface and switch it over or onward, for example switching down or up one level.

As a possible extension, the adaptation manager has a system interface with which system users or other systems may change the presettings of the system. Presettings may be for example priorities for an order of changes of adaptation levels of various categories of software components. Thus it may be provided that in the event of a critical loading of the system, for example, game applications are the first to be reduced in scale, before this happens to adaptive navigation components.

The adaptation manager is able to evaluate various system-specific factors in order to ascertain a current system status. Such factors may be CPU capacity utilization and/or memory utilization, each of which may be averaged over a certain time period. Additional factors that may be considered include settings for power management of the system, for example reduced operating mode or full load, or requirements for integration of a new software component into the system.

Based on the assessment of the system status, the adaptation manager is designed to initiate appropriate measures in the event of a system overload. For example, it may query the power management system as to whether it is possible to change a current operating mode to provide more power or CPU performance. In addition, the adaptation manager may switch over or activate adaptation levels of the adaptive software components present in the system.

As a possible extension, the adaptation manager may include a module having algorithms for the predictive or anticipatory estimation of system capacity utilization.

The adaptive software components may include, as an extension, features for identifying their resource needs with regard to the different adaptation levels. They provide this information to the adaptation manager, so that the latter is able to make a better predictive estimate of the system capacity utilization. This is especially useful for software components that are to be loaded subsequently by software update or software upgrade.

The adaptive organization system and/or the system may be distributed over a plurality of hardware nodes, such as computers, controllers and the like, which are networked together.

Additional advantages and embodiments of the present invention may be seen from the description and the accompanying drawing.

It goes without saying that the features named above and those still to be explained below are usable not only in the various combinations indicated, but also in other combinations or individually, without going beyond the scope of the present invention. In particular, remarks about the organization system according to the present invention also apply correspondingly to the method according to the present invention and vice versa.

The exemplary embodiments and/or exemplary methods of the present invention is portrayed schematically in the drawing on the basis of an exemplary embodiment, and will be described in greater detail below with reference to the drawing.

### BRIEF DESCRIPTION OF THE DRAWING

FIG. 1 shows a schematic depiction of an exemplary embodiment of a system having an organization system.

### DETAILED DESCRIPTION

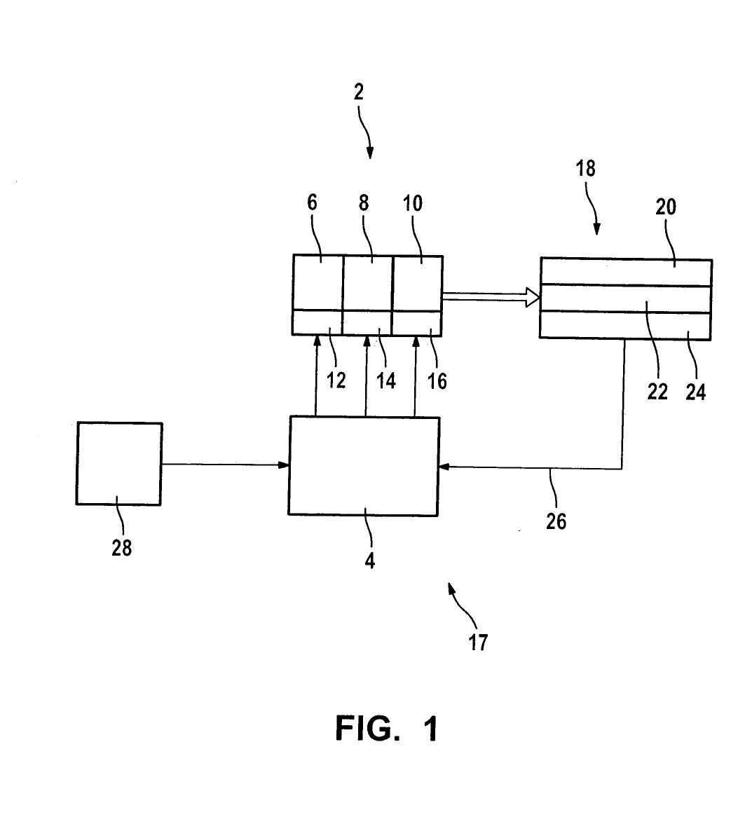

Organization system 2 shown schematically in FIG. 1 has an adaptation manager 4 and a number of adaptive software components 6, 8, 10. Each of these adaptive software components 6, 8, 10 has a plurality of adaptation levels and an interface 12, 14, 16 designed as an adaptation interface, all of which are of uniform or identical design.

Organization system 2 is designed for influencing a system 17 during ongoing operation of system 17. In the present specific embodiment, organization system 2 is integrated into this system 17. It is also conceivable for an organization system of this type to influence a system from outside. The influencing of system 17 includes the provision that adaptation manager 4 communicates via these interfaces 12, 14, 16 with adaptive software components 6, 8, 10, and in so doing in particular sets, adapts and/or controls them. At the same time, adaptation manager 4 chooses suitable adaptation levels for each of the adaptive software components 6, 8, 10 to influence system 17 (three parallel arrows).

A system status 18 of system 17 is characterized in the present specific embodiment by factors such as memory utilization 20, CPU capacity utilization 22 and power management 24. The factors, and hence system status 18, are influenced by the currently present adaptation levels of adaptive software components 6, 8, 10 (double arrow). At the same time, for example, a resource need and/or a range of features of system 17 is modifiable through adaptive software components 6, 8, 10.

A method for influencing system 17 includes the provision that input variables 26 that are based on the factors named above, and hence include information about the current system status 18 during ongoing operation of system 17, are conveyed to adaptation manager 4. On the basis of these input variables 26, a status assessment of system status 18 is carried out in adaptation manager 4. By using a module having algorithms, it is possible for adaptation manager 4 to perform a predictive estimation of a system capacity utilization of system 17. On the basis of the latter, adaptation manager 4 takes necessary measures to prevent a system overload, and/or to regulate a system overload so that system 17 is relieved. The adaptation levels for this are selected by adaptation manager 4 by controlling adaptive software components 8, 10, 12 through interfaces 12, 14, 16. Starting from the appropriately set adaptive software components 6, 8, 10, system status 18 (double arrow) is influenced, and thus the measures introduced are carried out.

Furthermore, external influences that act on system 17 from outside may be managed or accounted for through organization system 2. Such external influences are conveyed through a system interface 28 of adaptation manager 4, and are taken into account in the method to influence system 17. The external influences include parameters or manipulated variables as well as software updates as part of a subsequent installation of additional software components, including for example adaptive software components or software upgrades as part of an exchange of additional software components, including for example adaptive software components. In addition, presettings of system 17 may be changed via system interface 28.

The various adaptation levels in each software component 6, 8, 10 are suitable for example for use for navigation in a driver information system. A gradation of different versions may be made available here. A light version calculates only the shortest and fastest route. In a full version, an optimal route is calculated in addition. This places a significantly greater burden on system 17 given the same system resources, or takes significantly longer.

An additional example is offered by an application for a diagnosis in a driver information system, where a gradation according to different versions takes place through the adaptation levels of the adaptive software components in this case as well. In a light version a partial diagnosis occurs, in which only certain sub-systems are diagnosed. In a full version, a complete diagnosis of all sub-systems takes place.

1-12. (canceled)

13. An organization system for influencing a vehicle system during an ongoing operation of the system, comprising:
an adaptation manager; and
adaptive software components;
wherein the adaptation manager at least one of sets, adapts and controls the adaptive software components through interfaces of the adaptive software components.

14. The organization system of claim 13, wherein each adaptive software component includes a plurality of adaptation levels, wherein features of the adaptation levels characterize a range of at least one of adaptive functions and resource needs of the adaptive software components, the adaptation manager being configured to at least one of recognize and activate the adaptation levels of the adaptive software components through the interfaces.

15. The organization system of claim 13, wherein the adaptation manager has a system interface through which pre-settings of the system are modifiable.

16. The organization system of claim 13, wherein the adaptation manager is configured to ascertain an instantaneous system status of the system by evaluating system-specific factors.

17. The organization system of claim 13, wherein the adaptation manager has a module having algorithms for providing a predictive estimation of a system capacity utilization of the system.

18. The organization system of claim 13, wherein the adaptation manager is configured to take measures in the event of a system overload.

19. The organization system of claim 13, in which the organization system is integrated with the system that is to be influenced.

20. A method for influencing a vehicle system during ongoing operation of the system, the method comprising:
providing an adaptation manager and adaptive software components, each of the adaptive software components having an interface; and
at least one of setting, adapting and controlling the adaptive software components through the interfaces using the adaptation manager.

21. The method of claim 20, wherein at least one of a resource need and a range of features of the system is changed via the adaptive software components during the ongoing operation of the system.

22. The method of claim 20, wherein at least one of an exchange of software components and a subsequent installation of software components is taken into account.

23. A computer-readable data medium having computer program code, which is executable on a computer, comprising:
a program code arrangement for influencing a vehicle system during ongoing operation of the system, by at least one of setting, adapting and controlling adaptive software components through interfaces of the adaptive software components using an adaptation manager.

24. The computer-readable data medium of claim 23, wherein at least one of a resource need and a range of features of the system is changed via the adaptive software components during the ongoing operation of the system.

25. The computer-readable data medium of claim 23, wherein at least one of an exchange of software components and a subsequent installation of software components is taken into account.
